(19) United States
(12) Patent Application Publication
(10) Pub. No.: US 2003/0026897 A1
(43) Pub. Date: Feb. 6, 2003

(54) Automatic machine for varnishing flat wood, MDF or particle board, with ultraviolett powder

(76) Inventor: Jesus Francisco Barberan Latorre, Barcelona (ES)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/201,282

(22) Filed: Jul. 24, 2002

(30) Foreign Application Priority Data
Jul. 24, 2001 (ES) 200101729

(51) Int. Cl. B05D 3/02; B05D 1/12

(52) U.S. Cl. 427/180; 118/641; 118/621; 118/69; 427/318

(57) ABSTRACT

An automatic machine for varnishing an application piece including at least one of wood, medium density fiberboard, and particle board, with an ultraviolet powder, and a method of varnishing the application piece. A preheating device preheats the application piece. An application device applies the powder to the preheated application piece. A fusion device fuses the applied powder to the application piece. A curing device cures the fused powder on the application piece. A cooling device cools the cured powder on the application piece.

### CROSS-REFERENCE TO RELATED APPLICATIONS

This application claims the benefit of priority to Spanish patent application no. 200101729, filed Jul. 24, 2001, the disclosure of which is incorporated by reference herein in its entirety.

### FIELD OF THE INVENTION

The invention relates to a machine for varnishing wood and its derivatives including flat wood, wood moldings, medium density fiberboard, and particle board, with an ultraviolet powder that is melted or fused on the surface of an application piece to which it is applied.

### DISCUSSION OF THE RELATED ART

In the furniture and wood industry, it is known to apply varnish as a surface finish covering. Generally, “wet products,” such as water- or solvent-based varnishes, are used.

Conversely, powders or powdered products are generally applied to metallic pieces. Heat is applied to melt the powdered product directly on the application surface.

The use of powdered products provides a number of advantages over the use of wet products. For example, dry powder that is not melted on the application surface can be reused. Further, the application of dry powder does not require solvents or thinners.

For these reasons, it is desirable to apply powdered products on wood elements and its derivatives such as medium density fiberboard (MDF) or particle board. However, the powdered products generally applied to metals are not suited for application on wood, both because the fusion temperature of such products (approximately 180° C.) causes deterioration of the wood, and because the application of the powdered product is done through electrostatic charge while wood is a poor electric conductor, and the electrostatic charge therefore is very difficult or impossible to generate.

Recently, powdered products have been developed for painting or varnishing wood. These powdered products avoid the problems associated with the application of powder at high temperature by initially fusing the powder at a relatively low temperature (100-120° C.) and subsequently fusing the powder with ultraviolet radiation. Use of such powder products on wood achieves similar or even better results than the use of high temperature powders.

### SUMMARY OF THE INVENTION

The present invention provides an automatic varnishing machine that obviates the problem associated with the application of powdered products on wood, medium density fiberboard (MDF), or particle board pieces.

The machine includes a series of successive stages for transporting application pieces, including a first stage with means for performing piece preheating, a second stage with means for applying the powdered product on the pieces, a third stage with means for heating to fuse the powdered product applied to the pieces, and a fourth stage with means for curing and cooling the powdered product fused on the pieces.

The means for applying the powdered product include a transportation means, such as a band, for transporting the pieces, and a projection module for dispensing the electrostatically charged powdered product. The application of the powdered product is performed within an enclosed application zone including a suction system and a cleaning device (e.g., a scraper and/or a brush), such that excess powder can be reused.

The means for preheating include an infrared and/or a hot air module. The means for heating also include an infrared and/or a hot air module, such as a module providing constant wavelength infrared emission, a module providing infrared emission with wavelength modification, and a fan for equalizing a surface temperature of the piece.

The means for curing and cooling include a curing device, such as an ultraviolet radiation module, and an air projection module, such as an air-blower module, for curing and for cooling the piece, respectively.

A compact and fully automatic machine is provided for varnishing wood, MDF, or particle board pieces, with an ultraviolet powdered product that is melted or fused on a surface thereof. The machine minimizes the use of manual labor, as well as the use of environmentally damaging components, such as solvents, while providing optimal results with regard to mechanical and chemical resistance, and appearance, of the treated pieces.

### BRIEF DESCRIPTION OF THE DRAWINGS

FIG. 1 shows an elevation view of the varnishing machine of the present invention.

FIG. 2 shows a plan view of the machine of FIG. 1.

FIG. 3 shows an enlarged detail view of an application stage of the machine of FIG. 1.

FIG. 4 shows a profile view of the application stage of FIG. 3.

FIG. 5 shows an enlarged detail view of a cleaning device including a scraper in the application stage of FIG. 3.

FIG. 6 shows another enlarged detail view of the cleaning device including a brush in the application stage of FIG. 3.

FIG. 7 shows an enlarged detail view of a heating device in a fusion stage of the machine of FIG. 1.

FIG. 8 shows an enlarged detail of an air-blower device in the fusion stage of FIG. 7.

FIG. 9 shows an enlarged detail view of a curing stage of the machine of FIG. 1.

FIG. 10 shows an enlarged detail view of an air-blower device in a cooling stage of the machine of FIG. 1.

### DETAILED DESCRIPTION OF THE PREFERRED EMBODIMENTS

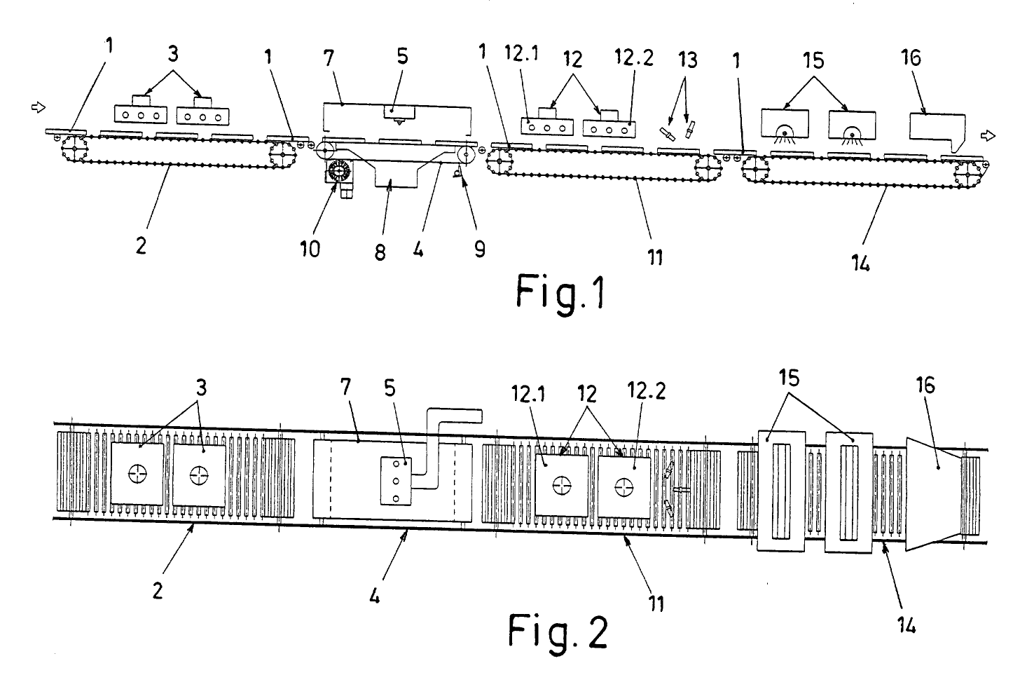

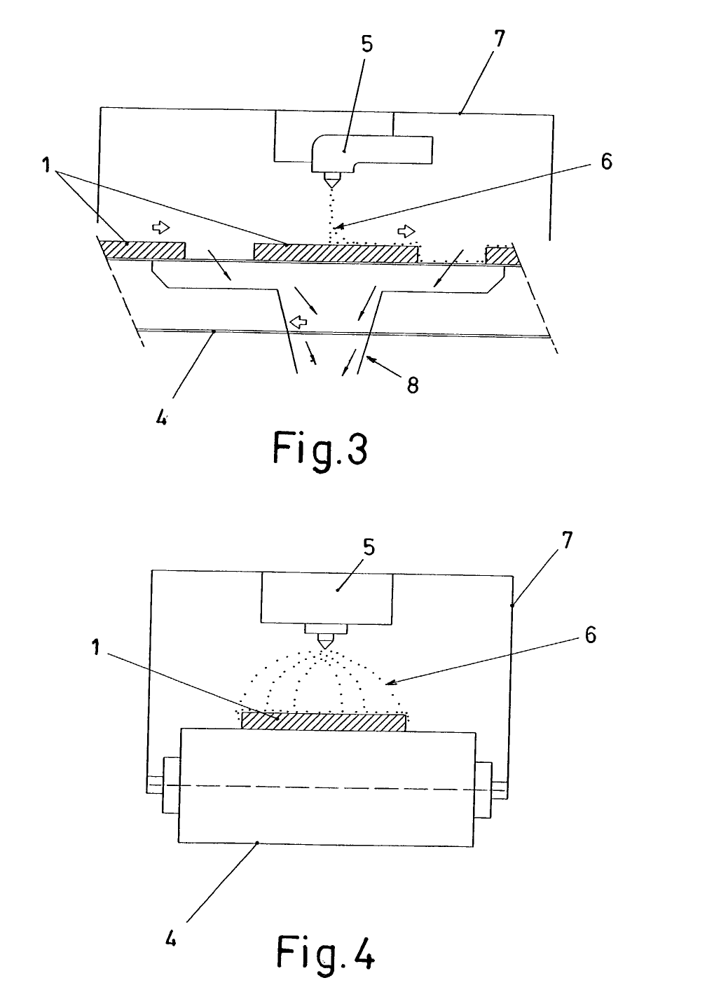

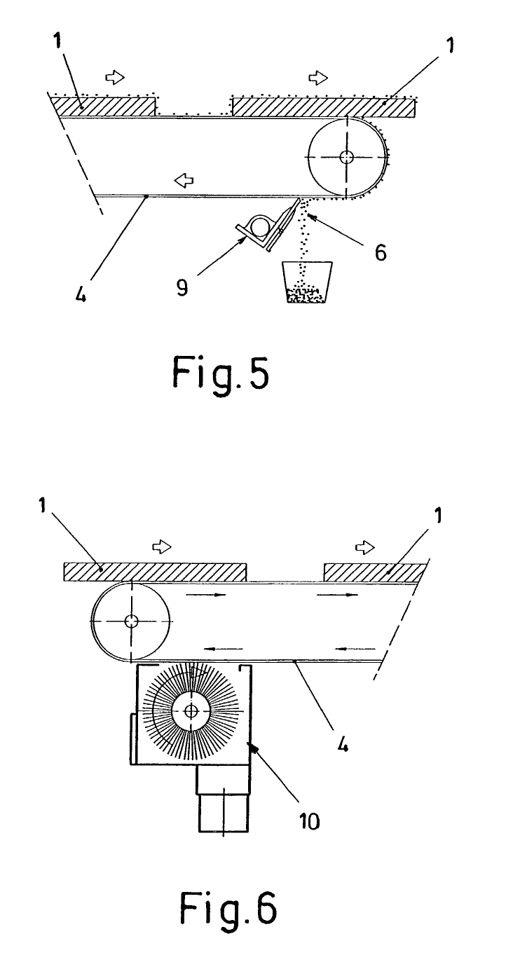

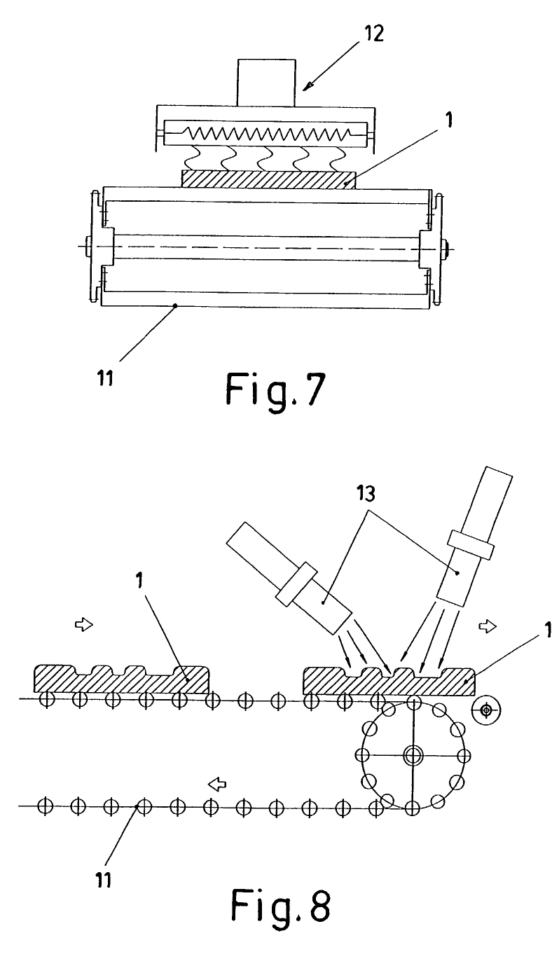

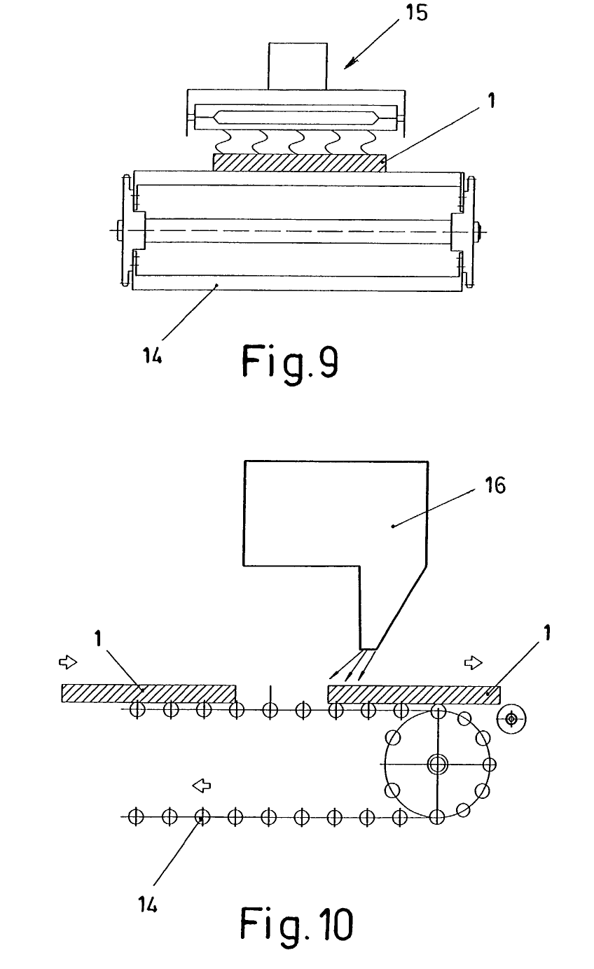

FIGS. 1-10 show a preferred embodiment of the automatic machine for applying an ultraviolet powder or powdered product to one or more application pieces including wood and its derivatives such as medium density fiberboard (MDF) and/or particle board.

The machine includes a series of successive transportation stages for transporting one or more application piece 1. A preheating device or stage includes a transportation means or device 2, preferably in the form of a chain, band, or similar device, on which the application pieces 1 are transported horizontally to a subsequent stage.

Disposed above the transportation means 2 is a heating element 3, such as an infrared and/or a hot air module, for preheating the application pieces 1. The preheating stage can include two or more heating elements 3.

An application device or stage includes a transportation means or device 4, such as a band, and, more preferably, an electrically powered and/or conducting band, on which the application pieces 1 are further transported horizontally.

Disposed above the transportation means 4 is at least one dispensing or projection module 5 for dispensing and applying the powdered product 6 onto the application pieces 1. The number of dispensing modules 5 can be selected in conjunction with a width of the application pieces 1 so that the pieces 1 are completely covered with the powdered product 6.

The application stage includes an application zone enclosed with a cover 7 and having a suction system 8. Such an arrangement prevents the excess powdered product 6 that is not applied to the application pieces 1 or the transportation means 4 from being dispersed outside of the machine and also gathers the excess powdered product 6 for reuse.

During application, the powdered product 6 is electrostatically charged by the dispensing module 5, such that the powder 6 is attracted to the application pieces 1 and the transportation means 4.

Disposed below a bottom surface of the transporting band 4 is at least one cleaning device, such as a scraper device 9 and/or an anti-static brush device 10. The cleaning device removes the powdered product 6 remaining on the transportation means 4 after traveling through the application zone, thereby recovering unused powdered product 6 for reuse.

A fusion device or stage includes a transportation means or device 11, preferably in the form of a chain, band, or similar device, on which the application pieces 1 covered with the powdered product 6 are further transported horizontally.

Disposed above the transportation means 11 is a heating element 12 such as an infrared and/or a hot air module, for fusing the powdered product 6 on the application pieces 1.

In a preferred embodiment, a short wave infrared module having a power control system that does not modify the emitted wavelength 12.1 and/or a short wave infrared module having a power control system that modifies the emitted wavelength 12.2 is used. Further, a fan 13 is preferably disposed above the transportation means 11 for equalizing a temperature on the surface of each of the application pieces 1 to which the powdered product 6 is applied, even when the application surface has a variable contour. Further, in a more preferred embodiment, two or more infrared modules 12.1 and/or 12.2 are disposed adjacent each other along the direction of travel of the application pieces 1 through the machine to successively irradiate the application pieces 1 with infrared radiation.

A curing and cooling stage includes a transportation means or device 14, preferably in the form of a chain, band, or similar device, on which the application pieces 1 covered with the fused product 6 are transported to an end of the machine.

The curing and cooling stage includes at least one curing device 15, such as an ultraviolet radiation emission module, disposed above the transportation means 14 for curing the fused product 6 on the application pieces 1. The curing device 15 can include two or more emission modules.

The curing and cooling stage also includes at least one cooling device 16, such as an air-blower module, disposed above the transportation means 14 for rapidly cooling the cured powdered product 6 on the surface of the application pieces 1. The cooling device 16 can include two or more air-blower modules.

Thus, by this arrangement, an ultraviolet powder or powdered product can be melted or fused on at least one surface of at least one application piece by the use of an automatic varnishing machine.

What we claim is:

1. A machine for varnishing an application piece including at least one of wood, medium density fiberboard, and particle board, with an ultraviolet powder, the machine comprising:
a means for preheating the application piece;
a means for applying the powder to the preheated application piece;
a means for fusing the applied powder to the application piece;
a means for curing the fused powder on the application piece; and
a means for cooling the cured powder on the application piece.

2. The machine according to claim 1, wherein the means for applying comprises an electrically conducting band adapted to transport the application piece, a projection module disposed above the band adapted to apply the powder to the application piece through electrostatic charge, and a projection zone enclosed by a cover having a suction system adapted to recover powder that is deposited on neither the band nor the application piece.

3. The machine according to claim 2, wherein the means for applying further comprises a scraper and an anti-static brush disposed below the band adapted to remove powder from the band.

4. The machine according to claim 1, wherein the means for preheating comprises an infrared module adapted to preheat the application piece.

5. The machine according to claim 1, wherein the means for fusing comprises an infrared module adapted to fuse the applied powder to the application piece.

6. The machine according to claim 1, wherein the means for fusing comprises two infrared modules that are disposed adjacent each other along a direction of travel of the application piece through the machine adapted to successively irradiate the application piece with infrared radiation.

7. The machine according to claim 1, wherein the means for fusing comprises a fan adapted to equalize a temperature of a surface of the fused powder on the application piece.

8. The machine according to claim 1, wherein the means for curing comprises a means for ultraviolet emissions.

9. The machine according to claim 1, wherein the means for ultraviolet emissions comprises an ultraviolet radiation emission module adapted to cure the fused powder.

10. The machine according to claim 1, wherein the means for cooling comprises an air-blower module adapted to cool the fused powder.

11. A machine for varnishing an application piece including at least one of wood, medium density fiberboard, and particle board, with an ultraviolet powder on successive transportation stages, the machine comprising:
a first transportation stage comprising means for preheating the application piece;
a second transportation stage comprising means for applying the powder to the preheated application piece;
a third transportation stage comprising means for fusing the applied powder to the application piece;
a fourth transportation stage comprising means for curing the fused powder on the application piece; and
a final transportation stage comprising means for cooling the cured powder on the application piece.

12. A method of varnishing an application piece including at least one of wood, medium density fiberboard, and particle board, with an ultraviolet powder, comprising:
preheating the application piece;
applying the powder to the preheated application piece;
fusing the applied powder to the application piece; and
curing the fused powder on the application piece.

13. The method of varnishing according to claim 12, further comprising: cooling the cured powder on the application piece.

14. A machine for varnishing an application piece including at least one of wood, medium density fiberboard, and particle board, with an ultraviolet powder, the machine comprising:
a preheating device adapted to preheat the application piece;
an application device adapted to apply the powder to the preheated application piece;
a fusion device adapted to fuse the applied powder to the application piece;
a curing device adapted to cure the fused powder on the application piece; and
a cooling device adapted to cool the cured powder on the application piece.
